(19) United States
(12) Patent Application Publication
(10) Pub. No.: US 2003/0182170 A1
(43) Pub. Date: Sep. 25, 2003

(54) Computer sofware program for an interactive multi-media calendar

(75) Inventor: Randy David Meunitz, Valencia, CA (US)

Correspondence Address: Rozsa & Chen LLP, 15910 Ventura Boulevard Suite 1601, Encino, CA, 91436-2815, US

(73) Assignee: Thomas I. Rozsa

(21) Appl. No.: 09/522,263

(22) Filed: Mar. 9, 2000

(51) Int. Cl. G06F 17/60

(52) U.S. Cl. 705/9

(57) ABSTRACT

A computer software program product recorded on a computer readable CD-ROM for providing an interactive multi-media calendar on a computer system having a video monitor and audio speakers. The interactive multi-media calendar program includes program instructions for presenting a particular date in a screen display on the video monitor. It also includes program instructions and video clip files for displaying a video clip associated with the particular date within the screen display, and program instructions and audio track files for playing back an audio track corresponding to the video clip through the audio speakers. The interactive multi-media calendar program also has scheduling capabilities, and automatic launch features for establishing links to web pages maintained by other computer systems on the Internet™.

### BACKGROUND OF THE INVENTION

1. Field of the Invention

The present invention generally relates to the field of computer software programs. More particularly, the present invention relates to the technical field of computer software programs for computerized calendaring systems.

2. Description of the Prior Art

Computer software programs for providing computerized calendaring systems have been developed over the years. Such programs can be executed on a computer system which includes a video monitor. They typically provides the functions of presenting a screen display of yearly, monthly or daily calendars on the video monitor. Many programs also provide other useful functions such as allowing a user to schedule calendar events.

The following three (3) prior art patents are found to be pertinent to the field of the present invention:

1. U.S. Pat. No. 5,899,979 issued to Miller et al. on May 4, 1999 for “Method And System for Automatically Integrating Scheduled Work Items Onto An Electronic Calendar” (hereafter “Miller”);

2. U.S. Pat. No. 5,936,625 issued to Kahl et al. on Aug. 10, 1999 for “Computerized Calendar Showing Scheduled Events Which May Be Edited, Magnified, Or Scrolled Within A Monthly View” (hereafter “Kahl”); and

3. U.S. Pat. No. 6,018,343 issued to Wang et al. on Jan. 25, 2000 for “Web Calendar Architecture And Uses Thereof” (hereafter “Wang”).

Miller discloses an electronic scheduling calendar which is made more useful to a user by merging to-do list items onto an event list schedule, as it provides the functions for the user to assign priorities to the to-do list items and estimate of how much time is required to complete each item. Further, upon request by the user, the to-do list items can be placed onto the event list in an available time slot on an available day.

Kahl discloses a method of providing a monthly calendar view in a computer system which uses either textual information or vertically stacked busy bars. When textual information is utilized, the textual information includes a start time and a brief description of the event, where the textual information can be added or edited. When vertically stacked busy bars are utilized, the bars may each represent a predetermined time frame, and the presence of a bar indicates an event is scheduled during that time frame. The monthly calendar view can further provide an enlarged full text description of the event by placing an icon over the event and selecting the event.

Wang discloses an architecture for facilitating web-based client-side calendar event scheduling. The architecture includes a web calendar scheduling tool which takes input via either a mouse and/or a keyboard to achieve: (a) an Internet personal organizer; (b) multi-media effects associated with scheduled events; (c) an Internet groupware that shares group members' individual schedules; (d) an Internet transaction associated with scheduled events; and (e) an open platform that supports Java applet™.

While various computerized calendaring system have been introduced, there is still a need to have a computer software program recorded on computer readable media for providing an interactive multi-media calendar.

### SUMMARY OF THE INVENTION

The present invention is a computer software program recorded on computer readable media for providing an interactive multi-media calendar.

It is an object of the present invention to provide a computer software program that generates an interactive multi-media calendar.

It is also an object of the present invention to provide a computer software program for an interactive multi-media calendar which is recorded on a computer readable medium.

Described generally, the present invention is a computer software program recorded on computer readable media for providing an interactive multi-media calendar on a computer system having a video monitor and audio speakers. The interactive multi-media calendar program includes program instructions for presenting a particular date in a screen display on the video monitor. It also includes program instructions and video clip files for displaying a video clip associated with the particular date within the screen display, and program instructions and audio track files for playing back an audio track corresponding to the video clip through the audio speakers. The interactive multi-media calendar program also provides scheduling capabilities, and features for automatically linking to web pages maintained by other computer systems on the Internet™. The program may also provide a “date-lock” feature for preventing the provision of any multi-media effect associated with a future date.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is an illustrative systematic block diagram showing a preferred embodiment of a computer system arrangement for implementing the present invention.

FIG. 2 is an illustrative systematic block diagram showing a preferred embodiment of a computer network arrangement for accommodating preferred features of the present invention.

FIG. 3 is an illustrative flow chart diagram showing a preferred embodiment of the present invention computer software program for providing an interactive multi-media calendar.

FIG. 4 is an illustrative diagram showing a main menu screen display of a preferred embodiment of the present invention computer software program for providing an interactive multi-media calendar.

FIG. 5 is an illustrative diagram showing a month view screen display of a preferred embodiment of the present invention computer software program for providing an interactive multi-media calendar.

FIG. 6 is an illustrative diagram showing a daily view screen display of a preferred embodiment of the present invention computer software program for providing an interactive multi-media calendar.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

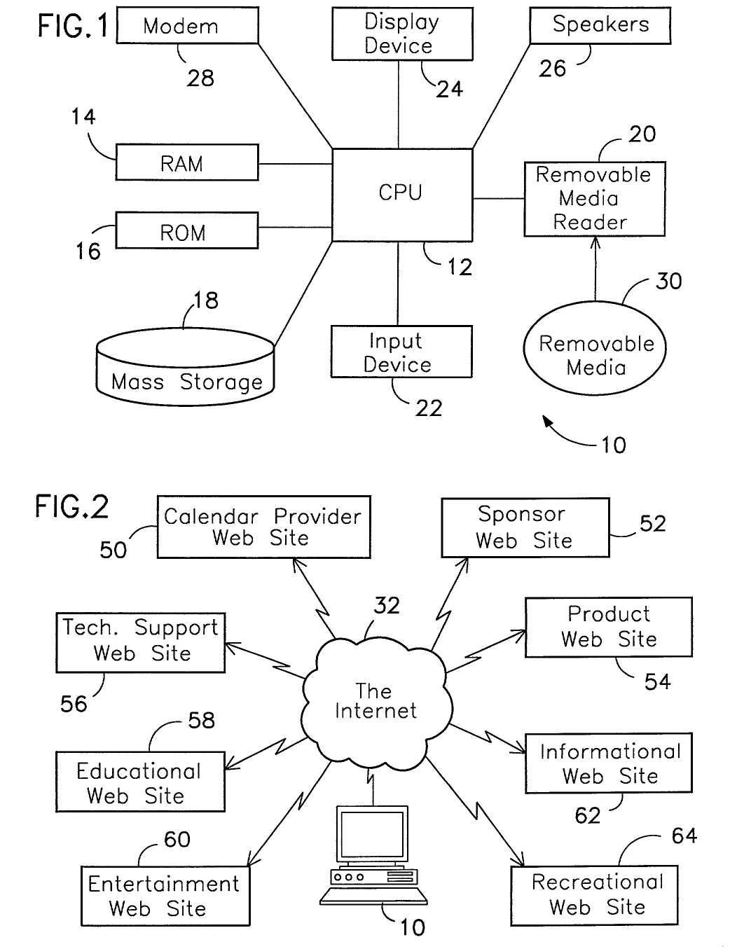

Referring to FIG. 1, there is illustrated a systematic block diagram showing a preferred embodiment of an arrangement of a computer system 10 for implementing the present invention. By way of example, the computer system 10 includes a central processing unit (CPU) 12 for performing logical and computational functions and execution of programing instructions.

The computer system 10 may also include one or more memory devices connected to CPU 12, such as a random access memory (RAM) device 14 for temporarily storing data and information to be processed by CPU 12, and a read-only memory (ROM) device 16 for storing system and program codes and instructions to be executed by CPU 12.

The computer system 10 may also include one or more mass data storage and/or transferring devices 18 connected to CPU 12, such as a hard disk drive; and one or more removable medium readers or drives 20 connected to CPU 12, such as a floppy disk drive, a tape drive, a CD-ROM drive, etc. The removable medium reader or drive 20 is used for accessing, storing and/or transferring data and files recorded on a removable medium 30 such as a floppy disk, a tape or a CD-ROM, etc. Such removable media are computer readable media which means that the program contents contained thereon can be read and executed by CPU 12.

The computer system 10 may also include one or more input devices 22 connected to CPU 12, such as a keyboard and a mouse; a display device 24 connected to CPU 12, such as a monitor; one or more audio output devices 26 connected to CPU 12, such as stereo loudspeakers; and one or more communication devices 28 connected to the CPU 12, such as a modem, for communicating and exchanging data and files with other computer systems.

The communication between computer system 10 and other computer systems may be established directly via cables or telephone lines, or indirectly via global computer networks 32 such as the Internet, as shown in FIG. 2.

The present invention a computer software program for providing an interactive multi-media calendar. The program is designed to be recorded on a computer readable medium, such as a CD-ROM or a floppy disk, and to be ran on a stand alone computer system. In other words, executing the program a computer system does not require the computer system to be connected with other computer system through, e.g., the Internet. The whole program contents are contained in one computer readable medium, which does not require the computer to search for or download other files from other computer systems through, i.e., the Internet. The program does embody, however, features that can take the advantages of connection with other computer system over the Internet, as described in detail later.

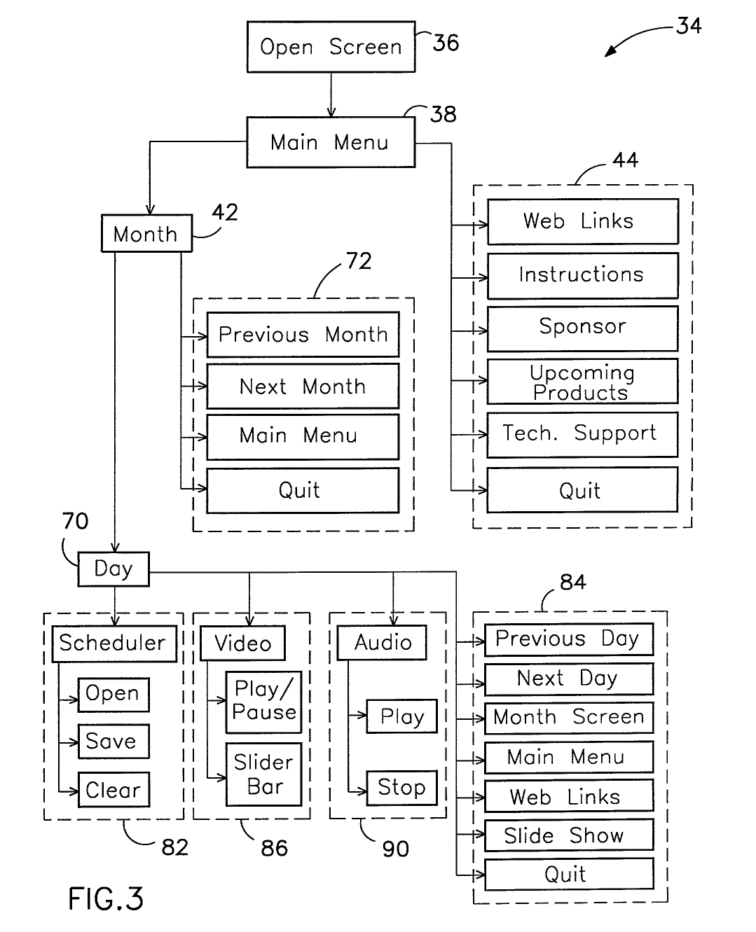

Referring to FIG. 3, there is shown a flow chart diagram showing a preferred embodiment of the present invention computer software program 34 for providing an interactive multi-media calendar recorded on a computer readable medium such a CD-ROM. The program may contain an “auto-run” routine such that when the computer readable medium is inserted or loaded into its driver, the program will load and start itself automatically. Alternatively a user may choose the program from a menu system or icon display as often used in conventionally available computer operating systems such as Microsoft® Windows™ 98.

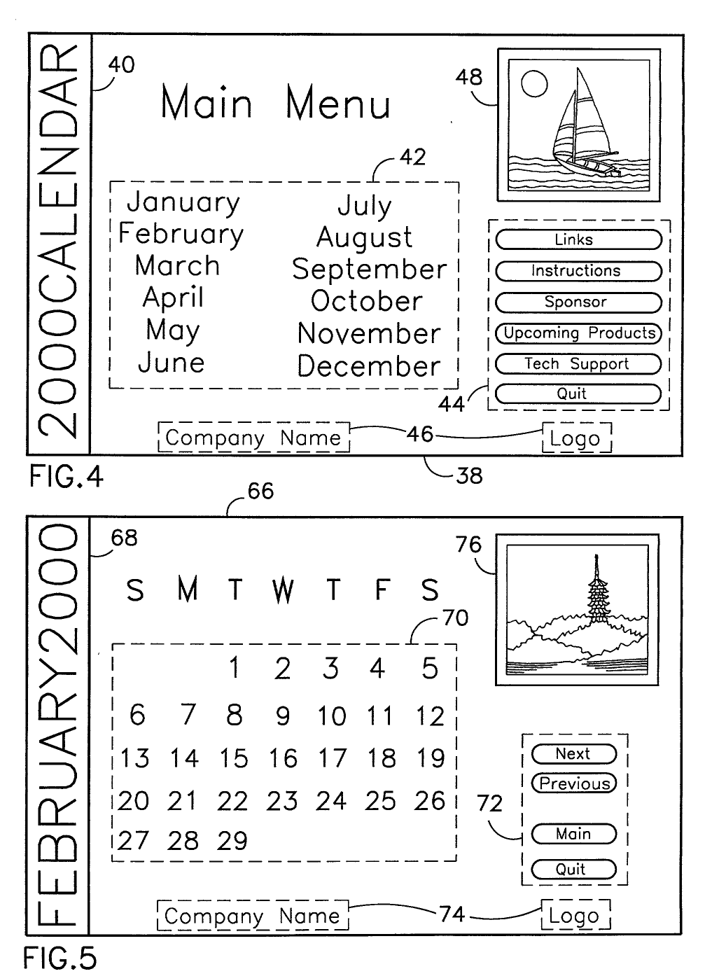

Referring to FIGS. 3 and 4, when program 34 starts, it will display an Open Screen 36, which then fades into a Main Menu screen 38, as shown in FIG. 4 as an example. The Main Menu screen 38 displays the calendar year 40, a list of the twelve (12) months 42, a set of function buttons 44, and a company name and/or logo 46. The Main Menu screen 38 may also include an image display area 48 which may display a graphic image, a still picture, a slide show or a video clip. When the calendar program is executed, audio background may be provided through the computer's internal or external loudspeaker systems.

The company name and/or logo 46 may be used to present to the user of the calendar the identity of the producer(s), provider(s), sponsor(s), advertiser(s) and/or promoter(s) that may be of interest to the user of the calendar. For example, the calendar can be specially produced for a particular company that distributes the CD-ROM with the calendar program recorded thereon as a gift or promotional item, in which case the name and/or logo of that particular company can be located in place of 46.

The function buttons 44 may include a Web Link button which may be used by the user to link the user's computer to other web sites if it is connected on-line; an Instruction button which may be used by the user to obtain user instructions; a Sponsor button which may be used by the user to retrieve information on the sponsor(s); an Upcoming Products button which may be used by the user to obtain information of product updates; an Technical Support button which may be used by the user to get technical support; and a Quit button which may be used by the user to exit the calendar program.

The user instructions, sponsor information, product updates, and technical support files may be recorded on the same CD-ROM on which the calendar program itself is recorded, so that all these information may be retrieved when the calendar program is ran on a stand-alone computer without dependency on other computer systems or without access to the Internet.

Alternatively, such data files may be transferred from the CD-ROM to a hard disk drive of the user's computer so that they may be accessed from the hard disk drive. Depending on the access speed of the CR-ROM drive and the hard drive, sometimes it may be preferred to access such data files from the hard drive if its access speed is greater.

However, as shown in FIG. 2, if the user's computer is connected on-line, e.g., to the Internet, with other computer systems, then the present invention calendar program also embodies the feature of allowing the user to link directly to other web site to obtain most updated information therefrom, in which case the calendar program will automatically launch a web browser program such as Microsoft® Internet Explorer™ or Netscape® NetCommunicator™ and display the linked web site, when the user clicks on corresponding buttons. For example, when the user clicks on the Instruction button, the program can automatically establish link to the program provider's web site 50 which may be used by the user to obtain user instructions; when the user clicks on the Sponsor button, the program can automatically establish link to a sponsor's web site 52 which may be used by the user to retrieve information on the sponsor; when the user clicks on the Upcoming Products button, the program can automatically establish link to a product vendor's web site 54 which may be used by the user to obtain information of product updates; when the user clicks on the Technical Support button, the program can automatically establish link to a technical support web site 56 which may be used by the user to get technical support; and when the user clicks on the Web Link button, the program can automatically establish links to other useful web sites such as educational web site 58, entertainment web site 60, informational web site 62, and recreational web site 64, etc.

It should be noted, however, that while providing web links is one of the many desirable features of the present invention calendar program, the program can run on a stand-alone computer by itself and does not necessarily require the Internet access or communication with other computer systems.

From the Main Menu screen 38 as shown in FIG. 4, a user may click on any one of the twelve (12) months to enter into the Month View screen 66 as shown in FIG. 5. Referring to FIGS. 3 and 5, the Month View screen 66 displays the calendar month 68, a list of the dates 70, a set of function buttons 72, and a company name and/or logo 74. The Month View screen 66 may also include an image display area 76 which may display a graphic image, a still picture, a slide show or a video clip. The function buttons 72 may include a Next Month button, a Previous Month button, a Main Menu button, and a Quit Button.

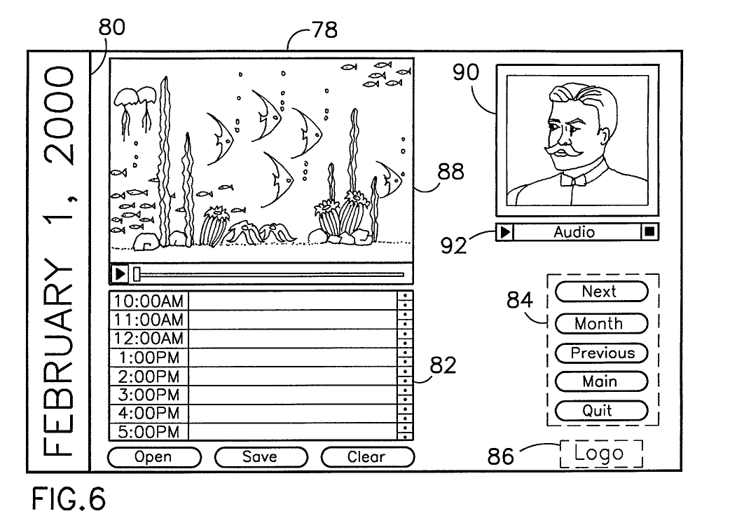

From the Month View screen 66 as shown in FIG. 5, a user may click on any one of the dates to enter into the Daily View screen as shown in FIG. 6. Referring to FIGS. 3 and 6, the Daily View screen 78 displays the calendar date 80, a scheduler dialog box 82, a set of function buttons 84, and a company name and/or logo 86. The function buttons 84 may include a Next Day button, a Previous Day button, a Month View button, a Main Menu button, and a Quit Button.

The scheduler dialog box 82 may be used to allow a user to input, edit and/or delete an appointment or an event. It may include an Open button, a Save button and a Clear Button for the user to open, save and/or clear a schedule file or entry, respectively.

The Daily View screen 66 also include a video display area 88 which is used to display a video clip. A video clip is a series of motion images displayed with or without associated sound effects. A video clip file is a file containing digital data of the motion images and associated sound effects, and may further containing executable instructions for displaying the motion images on the computer monitor and playing the sound effects through the computer speaker system. The video clip files are preferably recorded together with the calendar program on the same medium such the CD-ROM. The video display area 88 may include a Play/Pause button for starting/pausing the video display and a slider bar for indicating the length and progress of the video display.

The Daily View screen 78 may also include an image display area 90 which may display a graphic image, a still picture, a slide show or a video clip. Audio playback control buttons 92 may also be provided to playback an audio track corresponding to the image display 90. An audio track is a segment of voice (monolog or dialog), music, other sound and/or their mixtures playable through the computer's speaker system. An audio track file is a file containing digital data of the sound segment, and may further containing executable instructions for playing back the sound segment through the computer speaker system. The audio track files are preferably recorded together with the calendar program on the same medium such the CD-ROM. The audio playback control buttons 92 may include a Play/Pause button and a Stop button and may further include a slider bar.

The video and audio tracks displayed or played at a particular date may contain materials related to events or significance corresponding to that particular date. Alternatively they may be totally unrelated to the date, but rather simply materials related to a particular sponsor, product or subject. One of the unique features of the present invention program is that for each calendar date and/or month, there is provided video display and/or audio playback which makes the calendar an interactive and multi-media experience of the user. In addition, the program may have a built-in “date-lock” feature preventing the access of video and/or audio track files corresponding to a future date.

The present invention has many unique and advantageous features. It is recorded on a computer readable media such as a CD-ROM and can be ran on a stand-alone computer system. For each date displayed on the calendar, there is at least one associated video clip which can be displayed on the computer video monitor, and/or at least one associated audio track which can be played back on the computer speaker system. The video clip files and the audio track files are all recorded on the same computer readable media on which the calendar program itself is recorded, so that he computer readable media containing the calendar program can be distributed as a complete unit as a gift or promotional item which serves as a powerful advertising tool.

In addition, when the computer system is connected on-line to, e.g., the Internet, the program can automatically launch web browser programs loaded on the computer system and establish links to the web sites maintained by other computer system, so that the user of the calendar program can readily access information and services provided by such other web sites.

The calendar program also provides other useful and/or optional features such as the scheduling functions which enable a user to schedule tasks, events and appointments, etc., and “date-lock” functions which prevents the “pre-mature” display of multi-media effects associated with a future date.

Defined in detail, the present invention is a computer software program product recorded on a computer readable CD-ROM for providing an interactive multi-media calendar on a computer system having a video monitor and audio speakers, comprising: (a) computer readable means for presenting a particular date in a screen display on said video monitor; (b) computer readable means for displaying at least one video clip associated with said particular date within said screen display; (c) computer readable means for playing back at least one audio track corresponding to said video clip through said audio speakers; (d) computer readable means for scheduling functions; and (e) computer readable means for preventing the provision of any multi-media effect associated with a future date.

Defined broadly, the present invention is a computer software program product recorded on a computer readable medium for providing an interactive multi-media calendar on a computer system having a video monitor and audio speakers, comprising: (a) computer readable means for presenting a particular date in a screen display on said video monitor; (b) computer readable means for displaying at least one video clip associated with said particular date within said screen display; and (c) computer readable means for playing back at least one audio track corresponding to said video clip through said audio speakers.

Defined more broadly, the present invention is a computer software program product recorded on a computer readable medium for providing an interactive multi-media calendar on a computer system having multi-media capabilities, comprising: (a) computer readable means for displaying a particular date on said computer system; and (b) computer readable means for providing at least one multi-media effect associated with said particular date through said computer system.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and for disclosure of an operative embodiment and not to show all of the various forms or modifications in which the present invention might be embodied or operated.

The present invention has been described in considerable detail in order to comply with the patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. A computer software program product recorded on a computer readable medium for providing an interactive multi-media calendar on a computer system having multi-media capabilities, comprising:
a. computer readable means for displaying a particular date on said computer system; and
b. computer readable means for providing at least one multi-media effect associated with said particular date through said computer system.

2. The computer software program product as defined in claim 1, wherein said computer readable medium is a CD-ROM.

3. The computer software program product as defined in claim 1, wherein said at least one multi-media effect is displaying a video clip.

4. The computer software program product as defined in claim 1, wherein said video clip is stored as a digital data file recorded on said computer readable medium.

5. The computer software program product as defined in claim 1, further comprising computer readable means for providing at least one additional multi-media effect associated with said particular date through said computer system.

6. The computer software program product as defined in claim 5, wherein said at least one additional multi-media effect is playing back an audio track.

7. The computer software program product as defined in claim 6, wherein said audio track is stored as a digital data file recorded on said computer readable medium.

8. The computer software program product as defined in claim 1, further comprising computer readable means for scheduling functions.

9. The computer software program product as defined in claim 1, further comprising computer readable means for establishing links with other computer systems via a global computer network.

10. The computer software program product as defined in claim 1, further comprising computer readable means for preventing the provision of any multi-media effect associated with a future date.

11. A computer software program product recorded on a computer readable medium for providing an interactive multi-media calendar on a computer system having a video monitor and audio speakers, comprising:
a. computer readable means for presenting a particular date in a screen display on said video monitor;
b. computer readable means for displaying at least one video clip associated with said particular date within said screen display; and
c. computer readable means for playing back at least one audio track corresponding to said video clip through said audio speakers.

12. The computer software program product as defined in claim 11, wherein said computer readable medium is a CD-ROM.

13. The computer software program product as defined in claim 11, wherein said at least one video clip is stored as a digital data file recorded on said computer readable media.

14. The computer software program product as defined in claim 11, wherein said at least one audio track is stored as a digital data file recorded on said computer readable media.

15. The computer software program product as defined in claim 11, further comprising computer readable means for scheduling functions.

16. The computer software program product as defined in claim 11, further comprising computer readable means for establishing links with other computer systems via a global computer network.

17. The computer software program product as defined in claim 11, further comprising computer readable means for preventing the provision of any multi-media effect associated with a future date.

18. A computer software program product recorded on a computer readable CD-ROM for providing an interactive multi-media calendar on a computer system having a video monitor and audio speakers, comprising:
a. computer readable means for presenting a particular date in a screen display on said video monitor;
b. computer readable means for displaying at least one video clip associated with said particular date within said screen display;
c. computer readable means for playing back at least one audio track corresponding to said video clip through said audio speakers;
d. computer readable means for scheduling functions; and
e. computer readable means for preventing the provision of any multi-media effect associated with a future date.

19. The computer software program product as defined in claim 18, wherein said at least one video clip is stored as a digital data file recorded on said computer readable CD-ROM.

20. The computer software program product as defined in claim 18, wherein said at least one audio track is stored as a digital data file recorded on said computer readable CD-ROM.

21. The computer software program product as defined in claim 18, further comprising computer readable means for establishing links with other computer systems via a global computer network.
